(19) United States
(12) Patent Application Publication
(10) Pub. No.: US 2017/0102355 A1
(43) Pub. Date: Apr. 13, 2017

(54) ELECTROCHEMICAL SENSOR, AND A METHOD OF FORMING AN ELECTROCHEMICAL SENSOR

(71) Applicants: Patrick M. McGuinness, Pallaskenry (IE); Seamus P. Whiston, Raheen (IE); William A. Lane, Waterfall (IE); Thomas G. O'Dwyer, Arlington, MA (US); John Jude O'Donnell, Quin (IE); Bernard Stenson, Upper Manister (IE); Shane Geary, Sixmilebridge (IE); Helen Berney, Raheen (IE); Raymond J. Speer, Dalkey (IE)

(72) Inventors: Patrick M. McGuinness, Pallaskenry (IE); Seamus P. Whiston, Raheen (IE); William A. Lane, Waterfall (IE); Thomas G. O'Dwyer, Arlington, MA (US); John Jude O'Donnell, Quin (IE); Bernard Stenson, Upper Manister (IE); Shane Geary, Sixmilebridge (IE); Helen Berney, Raheen (IE); Raymond J. Speer, Dalkey (IE)

(21) Appl. No.: 14/879,738

(22) Filed: Oct. 9, 2015

(51) Int. Cl. G01N 27/413; H01G 9/00; H01G 9/22

(52) U.S. Cl. CPC G01N 27/413; H01G 9/22; H01G 9/0029

(57) ABSTRACT

It may be desirable to sense the concentration of a gas in another gas. This measurement may be important to warn of impending danger. Gas sensors may be made in batches by a manual process, leading to large variations in sensor performance between batches and indeed between sensors in a batch. This means the sensors often need individual calibration before use. The present approach to sensor design can make use of integrated circuit manufacturing techniques to give rise to sensors with well-matched and reproducible characteristics.

### FIELD

The present disclosure relates to the formation of electrochemical sensors.

### BACKGROUND

Electrochemical sensors may comprise three electrodes in contact with an electrolyte. These electrodes are normally identified as a working electrode, a counter electrode and a reference electrode. Generally speaking in such sensors the reference electrode is held at a constant potential with respect to the counter electrode and the presence of substances which interact with the electrolyte can invoke current flow between the working electrode and the counter electrode as a result of reduction/oxidation (REDOX) reactions at the working electrode. Other electrochemical sensors may only have a working electrode and a counter electrode and in such sensors the potential difference, current flow or resistance between those electrodes may be measured.

Generally speaking, such electrochemical sensors may be made on a one by one basis or by using techniques that are quite variable. As a result the sensors tend to vary from one to another. In some fields of use, such as carbon monoxide sensors, this is not too much of an issue as the trigger threshold for the associated electronics to issue an alarm is set so high that there can be no doubt that an unsafe level of carbon monoxide has been reached. However, for situations where greater precision and/or resolution are required then the sensors may have to be calibrated prior to use. This is generally expensive and/or time consuming.

### SUMMARY

According to a first aspect of this disclosure there is provided a method of forming an electrochemical sensor. The method can comprise using lithographic and etching techniques to process a substrate so as to form an electrochemical sensor having an enclosed electrolyte. The enclosed electrolyte is an electrical communication with at least first and second electrodes.

The use of integrated circuit manufacturing techniques can enable many sensors to be made in a single batch, and indeed distributed across a single substrate, thereby improving the manufacturability of such sensors, in that many more can be made at a time and more cost effectively, while also improving the matching from one sensor to the next such that calibration of each and every sensor is not required.

Furthermore the reliable and repeatable matching between sensors on the same wafer allows improved measurement techniques to be adopted. Thus some sensors may be sealed in a reference environment, for example by being in contact with a known gas at a known concentration, pressure or partial pressure, and may act as a reference for one or more other sensors. Sensors may also be provided in bridge or differential pair configurations, possibly with different operating potentials, gas flow path lengths, diffusion paths or diffusion membranes, such as to enable more sensitivity to changes in concentration of an analyte and/or to give additional robustness against rejecting signals from other fluids or chemicals.

### BRIEF DESCRIPTION OF THE DRAWINGS

The teachings of this disclosure will be discussed, by way of non-limiting examples, with reference to the accompanying drawings, in which:

FIG. 1 is a cross-section through an embodiment of an electrochemical sensor in accordance with the teachings of this disclosure;

FIG. 2 schematically illustrates a wafer at an initial phase of a fabrication process for the sensor shown in FIG. 1;

FIG. 3 shows the wafer after formation of a dielectric layer;

FIG. 4 shows the wafer after formation of a metallic layer that forms the reference electrode in the completed device;

FIG. 5 shows the wafer after deposition of more dielectric material;

FIG. 6 shows the wafer after the formation of first and second vias;

FIG. 7 shows the wafer of FIG. 6 after the formation of bond pads over the vias, and with a further conductor to make contact with the working electrode;

FIG. 8 shows the wafer after deposition of the working electrode;

FIG. 9 shows the wafer after a selective back side etch has been done to form reservoirs therein;

FIG. 10 shows the wafer after deposition of the metal that forms the counter electrode;

FIG. 11 shows the wafer after ion-beam etching to remove metal from the dielectric layer;

FIG. 12 shows the wafer after etching of the dielectric to expose the underside of the working electrode to the reservoir;

FIG. 13 shows the wafer after deposition of a gas diffusion layer;

FIG. 14 shows a variation of the device shown in FIG. 1 with a larger reservoir;

FIG. 15 is a cross-section through a sensor constituting a second embodiment of this disclosure;

FIG. 16 is a cross-section through third embodiment of a sensor which is a variation of the sensor of FIG. 15;

FIG. 17 shows the interposer in greater detail;

FIG. 18 shows the interposer in plan view;

FIGS. 19 to 22 show the formation of the further embodiment in greater detail;

FIG. 23 is a cross-section through a sensor constituting a fourth embodiment of this disclosure;

FIG. 24 is a cross-section through a sensor constituting a fifth embodiment of this disclosure;

FIG. 25 shows a wafer at the start of a manufacturing process to form the sensor shown in FIG. 24;

FIG. 26 shows the wafer after the formation of a patterned electrode in its surface;

FIG. 27 shows the wafer after etching through the gaps left in the patterned electrode;

FIG. 28 shows the wafer after a SF6 etch to form one or more voids beneath the electrode;

FIG. 29 shows the wafer after the electrolyte has been printed or otherwise deposited onto the electrode;

FIG. 30 shows the wafer after it has been capped;

FIG. 31 shows the gas flow path in the completed sensor;

FIG. 32 is a cross-section through a sensor in accordance with a sixth embodiment of this disclosure;

FIG. 33 shows a wafer after several processing steps have been performed to form a reservoir in the substrate, where the reference counter and working electrodes make contact with the reservoir;

FIG. 34 shows the wafer of FIG. 33 after the electrolyte has been introduced into the reservoir;

FIG. 35 shows the wafer after the reservoir has been capped;

FIG. 36 shows a variation to the arrangement shown in FIG. 32; and

FIG. 37 shows a further embodiment of a sensor.

### DESCRIPTION OF SOME EMBODIMENTS OF THIS DISCLOSURE

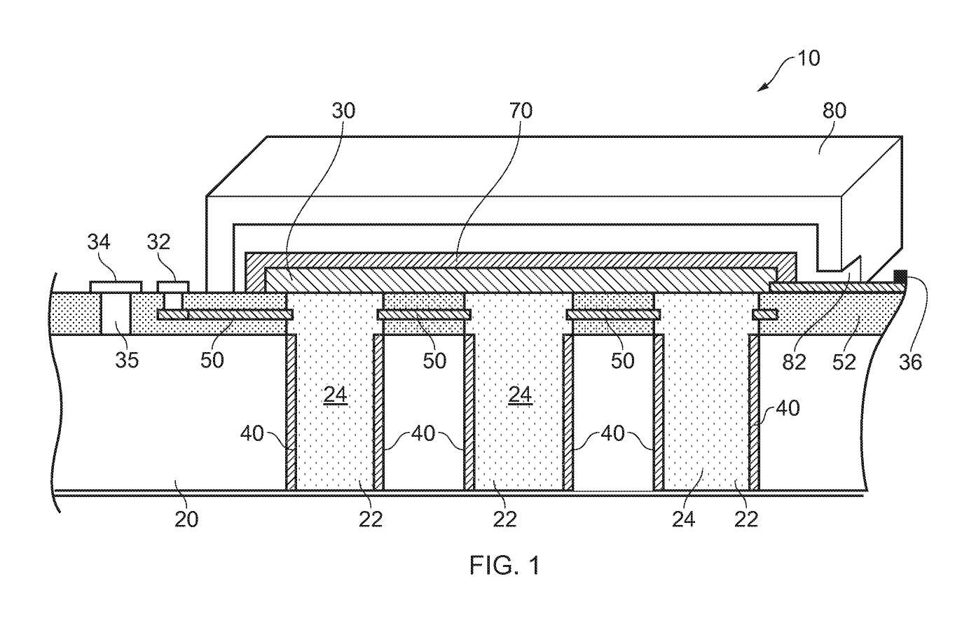

FIG. 1 schematically illustrates, in cross section, an electrochemical sensor constituting an embodiment of this disclosure. The sensor, generally designated 10, comprises a substrate 20 which has been processed to form a plurality of reservoirs 22 therein, each of which contain an electrolyte 24. The electrolyte 24 in each of the reservoirs is in contact with three electrodes, forming a working electrode 30, a reference electrode 32 and a counter electrode 34 which are in electrical connection with respective terminals. In the embodiment shown in FIG. 1 the substrate 20 is formed of doped silicon or some other conducting material such that the body of the substrate can also form part of the counter electrode 34. The interior of each of the reservoirs 22 has a significant portion thereof lined with a conductor 40 which forms an electrode interface with the electrolyte 24. It can be seen that if the substrate 20 was not sufficiently conducting additional tracks could be made to the conductive material 40 in order to form a functional counter electrode. The reference electrode can be formed as a perforated conductive layer 50 in contact with the reference electrode terminal 32, and isolated from the counter electrode 40 and the working electrode 30 by way of a suitable dielectric material 52. The counter electrode 40 is connected to a counter electrode terminal 34 by way of a via 35 and the conductive substrate 20. The working electrode 30, which in this example is porous (or at least gas permeable), is formed over the top of the reservoirs 22, with the device orientated as shown in FIG. 1, and is electrically connected to a working electrode terminal 36. A gas permeable membrane 70 may be deposited over the surface of the working electrode 30. Finally, if desired, a cap 80 may be placed over the working electrode. The cap may have one or more apertures, for example in the form of a slot 82 formed in one of its side walls, to control diffusion of a fluid, such as gas, into the region around the working electrode.

As will be discussed shortly, the arrangement formed in FIG. 1 can be created using semiconductor integrated circuit manufacturing techniques, such as for example photolithographic and etching techniques. As such, many hundreds or thousands of substantially identical sensors can be formed on a wafer. Each of the sensors on the wafer are subjected to the same processing steps as each other and consequently variation from one sensor to another sensor is minimal. This mass production of sensors can have at least two benefits. Firstly, by adopting the techniques from the semiconductor industry, the unit cost of each sensor can be made much lower. This enables sensors to be included in applications where hitherto their use would be precluded. For example, in a situation where multiple devices exist in an “internet of things” sensors for harmful environmental gases, for example carbon monoxide, may be included as an adjunct to devices which would not normally be expected to monitor for environmental threats, such as telephones, smart phones, computers, televisions, refrigerators, domestic appliances and so on. Similarly sensors receptive to all manner of other chemicals, such as alcohol on a person's breath, gases exhaled by an individual as a result of metabolic processes which may in turn help in diagnosis of disease, and so on may also be included in objects that have the potential to interact with persons. Such objects may include clothing, protective clothing (e.g. hard hats) or monitoring badges or other wearable monitors where unit cost and/or working lifetime may be significant commercial considerations. Similarly gas sensors may be provided within refrigerators to detect the products of decomposition of food and to alert users. These examples are not intended to be limiting, but merely to be illustrative of the variety of essential uses for inexpensive environmental sensors and the surprising places that they might be included.

Additionally, because the sensors are notionally identical, then calibration data from one sensor made using this micromachining technique may be used for additional sensors formed by the same technique, potentially at substantially the same time, and which are notionally identical.

An example of a process to form the electrochemical sensor shown in FIG. 1 will now be described. The process starts with a substrate 20 formed of low resistance silicon. Next, as shown in FIG. 3 a first dielectric layer, such as an oxide layer 100 is formed over the substrate 20. The first oxide layer 100 will, in the finished device, form part of the dielectric layer 52 illustrated in FIG. 1. In the next step, a metallic patterned layer, which, when viewed from above, may resemble a plate with holes formed in it or, alternatively, a plurality of gold circles interconnected to one another via a plurality of conductive tracks is formed over the surface of the oxide 100. The metal used to form this layer may be or include gold. The gold is designated 50 in FIG. 4 and forms the reference electrode in the completed sensor. In this example gold has been chosen because it is chemically inert. However other conductive materials may be used, either depending on the electrical resistance which can be tolerated in the reference electrode or depending on their interaction with the electrolyte. Thus, for example, other metals such as platinum or aluminum may be used in place of gold, or polysilicon may be used to form the patterned conductive tracks. The polysilicon may contact the electrolyte directly, or may interface with a metal electrode which in turn contacts the electrolyte 24. This latter approach can be preferred as the metal protects the silicon from oxidation.

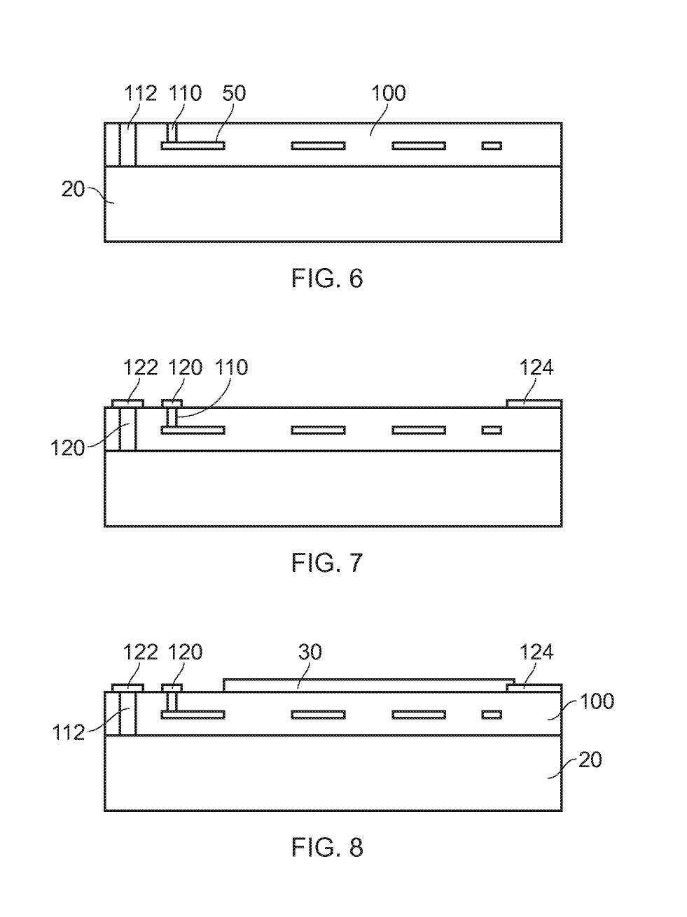

Following formation of the patterned conductive material 50 which forms the reference electrode, a further dielectric layer is formed over the layer 50, and planarized if necessary. If, for convenience, the dielectric is the same as the dielectric 100, then the structure shown in FIG. 5 is arrived at. The dielectric layer is then subjected to steps of photolithography, selected etching and removal of the mask material to form channels for the formation of the first and second vias at selected areas within the dielectric, such that the first via 110 which makes contact with the metal layer 50, and the second via 112 which makes contact with the low resistance silicon 20. The vias may be formed of any suitable material such as tungsten, gold, aluminum or polysilicon. The list is not exhaustive. The device formed so far is illustrated in FIG. 6. Then, and as illustrated in FIG. 7, metallic bond pads and interconnects are formed. Thus, a metallic bond pad 120, which may be in the form of electroplated gold, contacts the via 110 so as to form a terminal for the reference electrode. Similarly, bond pad 122 makes contact with the via 120 so as to form a terminal for the counter electrode. A metallic interconnect/bond pad 124 is provided which, in the finished device, makes a terminal for the working electrode. Moving on from the arrangement shown in FIG. 7, the next processing step is to pattern the wafer, for example by applying a suitable resist and then deposit the material of the working electrode. The working electrode, as shown in FIG. 8, is designated 30 so as to maintain conformity with the numbering used in FIG. 1. The working electrode is provided as a porous material such that gases on one side of the electrode (or chemicals or ions in solution) can come into contact with the electrolyte 24 in the finished device. Thus, the working electrode may have to form a gas, and liquid, solid interface where the three phases of matter can contact one another. The working electrode 30 may be chosen from any number of suitable working electrode materials. Thus, in the embodiment shown in FIG. 1, the working electrode 30 may be formed of a porous metal. Porous metal may be formed by electro-deposition at high current densities. Deposition may also be performed in the presence of small particles or filaments which can subsequently be dissolved, washed or burnt out of the material to leave a porous structure. In the example described herein, the working electrode is formed of gold deposited at sufficiently high current densities such that it becomes porous. However the use of other working electrode materials is not precluded, such as conductive polymer membranes or other porous structures which have been flushed or coated with metallic salts so as to give rise to conductive paths within the structure as a whole making it suitable to function as a working electrode. The working electrode 30 is in contact with the metallic interconnect 124 which in turn can form a bond pad or terminal for the active area forming the working electrode 30.

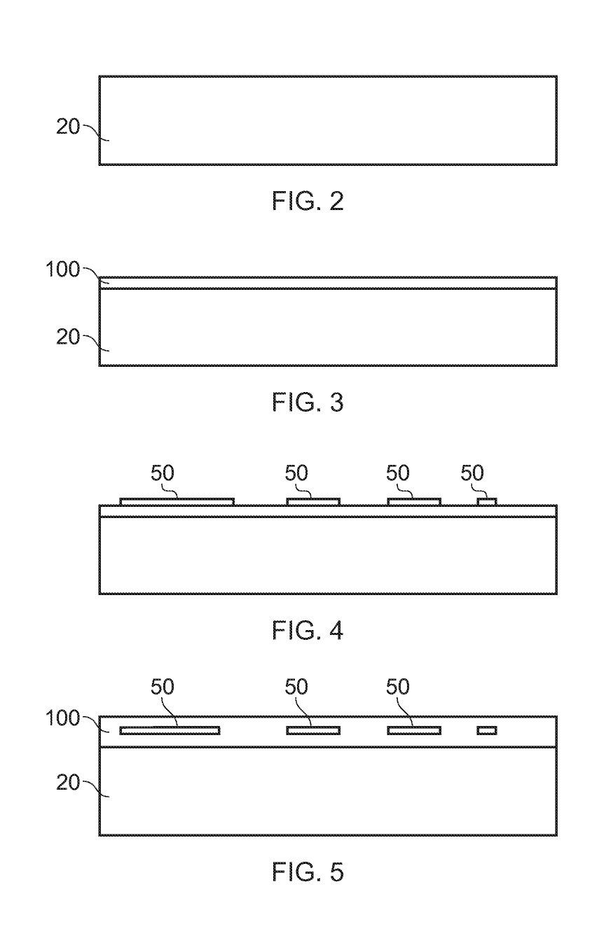

Thus far, all of the processing has been performed on a first side of the wafer. The wafer may now be inverted so as to perform a series of processes on its second side (backside processing). However, for consistency in the drawings, the wafer will continue to be illustrated in the same orientation as in FIGS. 2 to 8.

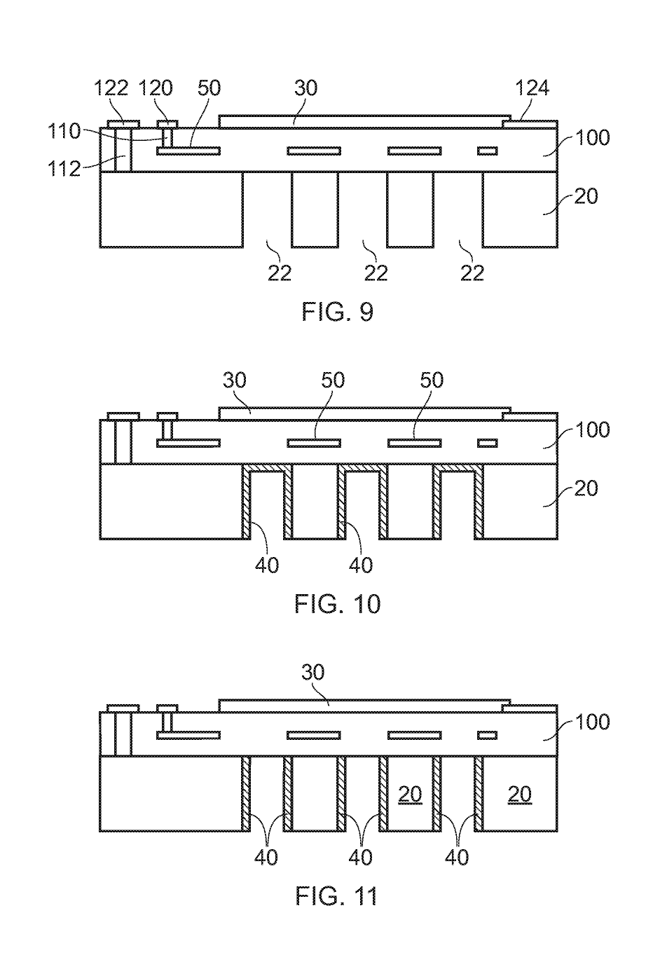

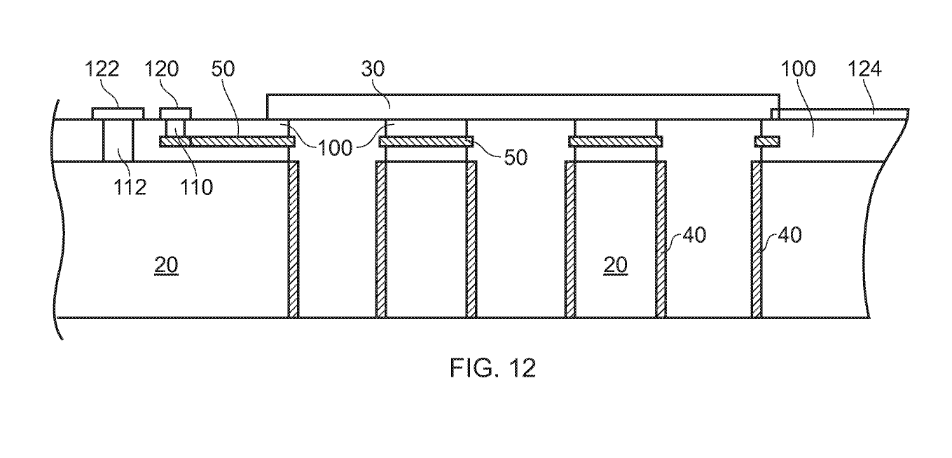

The process continues at FIG. 9 where the wafer 20 is patterned and then selectively etched to form a plurality of trenches, channels, or other recesses or voids which in the finished device form the reservoir 22 that holds the electrolyte 24. Next, and as shown in FIG. 10, the inner surface of the trench 22 has a metallic layer deposited on it. The metallic layer is designated 40 in FIG. 10 so as to maintain conformity with the numbering used in FIG. 1. The metallic layer may be any suitable material. For convenience, gold was used in this embodiment as it is inert. It can be seen that the deposition process, depending on the process used, may result in the dielectric 100 having metal deposited on it. If so, then the next step is an etch, such as an ion beam etch or reactive ion etching, to remove the metal 40 from over the dielectric 100, so as to arrive at the configuration shown in FIG. 11. Next selective etching of the dielectric 100 is performed so as to extend the channel/reservoir 22 such that it contacts the reference electrode and the working electrode 30. Such an arrangement is shown in FIG. 12.

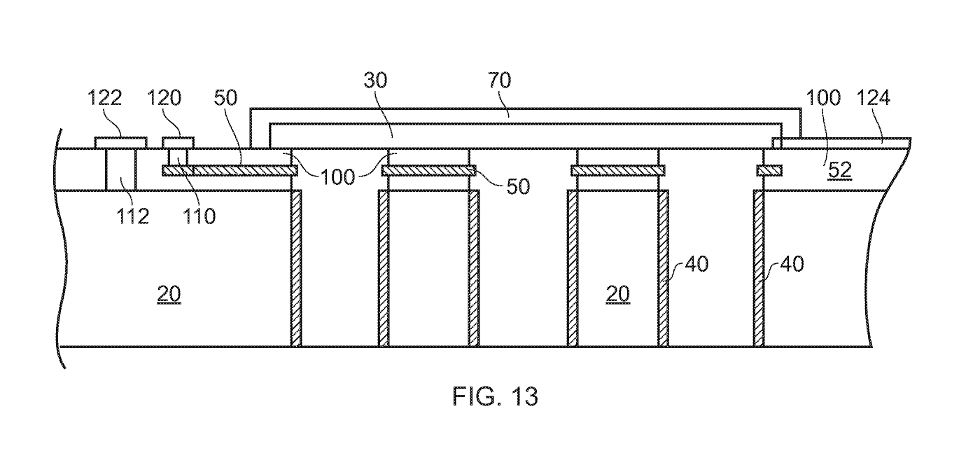

Optionally, and as shown in FIG. 13, an additional membrane 70 may be formed over the working electrode 30. The membrane 70 may be a gas diffusion membrane thereby controlling the amount of gas that diffuses to the working electrode 30. This is advantageous if it is desired to measure concentrations of gas, for example to give parts per millions. Additionally or alternatively, the membrane 70 may also act as the hydrophobic cover thereby reducing or substantially inhibiting the evaporation of the electrolyte.

The membrane 70 need not be passive. Indeed, it may contain one or more chemicals (reagents) that react with one or more chemicals that it is desired to detect (analytes). The result of that reaction may create a by-product which interacts at the interface between the working electrode 30 and the electrolyte 34 so as to be detected by the electrochemical cell.

In some uses of the electrochemical cell, it may be desired to detect analytes in a liquid environment. In which case the cell as shown in FIG. 12 or 13 may be packaged such that the working electrode 30, or the membrane layer 70 can be exposed to liquid.

In other embodiments which may be suitable for use in a gaseous environment, the arrangements of FIG. 12 or 13 may be protected by a cover, generally indicated 80, bonded over the uppermost surface of the electrochemical cell, as shown in FIG. 1. The cover 80 may also be formed by etching of a further silicon substrate. This has the advantage that the coefficients of thermal expansion of the cover and the substrate are matched, thereby reducing the risk of stress forming in the sensor. Additionally, the use of the silicon cover allows selective etching of the wall thereof to define one or more ports, such as port 82, which allow gas from the environment to diffuse towards the working electrode 30 of the sensor, optionally by way of the gas permeable membrane 70. The provision of a cover helps to protect the sensitive structure of the electrochemical sensor and also reduces the rate of evaporation of the electrolyte from the sensor.

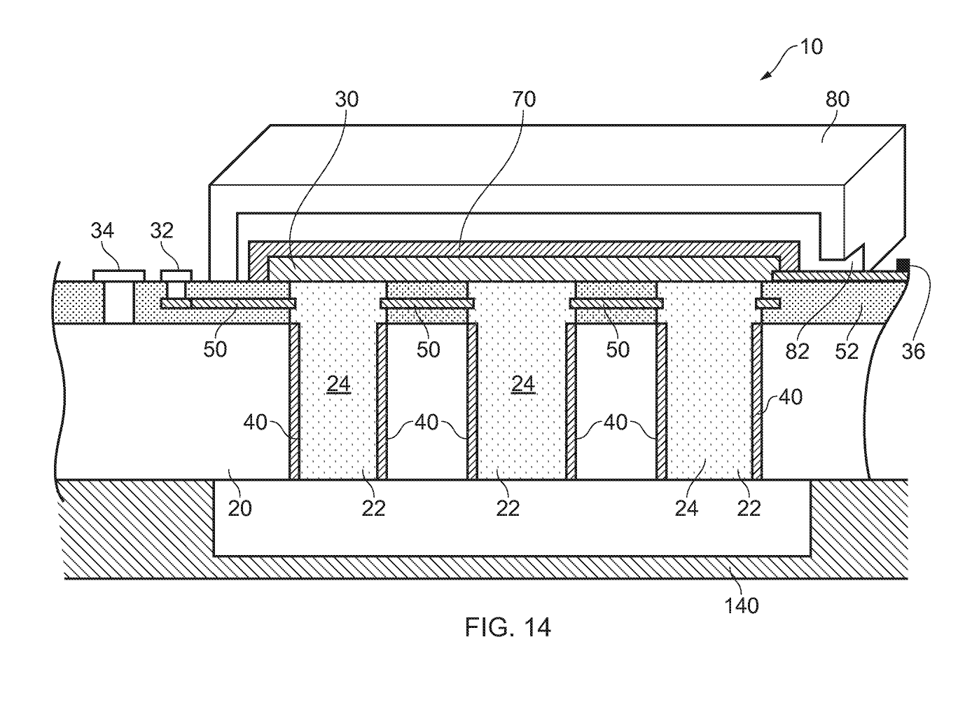

After all the semiconductor type processing steps have been finished, and hence the substrate will no longer be exposed to potentially elevated temperatures, then the electrolyte 24 can be introduced into the reservoirs 22 through the open holes in the base of the substrate. Such introduction may be performed by way of a printing process, such as screen printing or “ink jet” printing. Alternatively vacuum filling may be used. In such a process the wafer may be placed in an evacuated environment and the electrolyte is applied to the surface of the wafer. When the vacuum is released the electrolyte is sucked (or pushed depending on your point of view) into the reservoirs. The reservoirs can then be closed, for example by sticking a plastics membrane across the open holes so as to close them. It should be noted that any material that seals the electrolyte in is suitable for this job. In a further variation, a second cap component 140 similar to cap 80 may be filled with an electrolyte, for example electrolyte gel, and then bonded to the substrate 20 using a low temperature adhesive or similar so as to provide a reservoir of enhanced capacity. Such an arrangement is shown in FIG. 14.

After completion the wafer containing a plurality of sensors can be diced in order to separate them into individual components or into groups of individual components.

The possibility of providing several sensors due to their inexpensive nature and good matching, has potential advantages. The sensors may age in use, and hence one or more sensors may be kept unused for a period of time whilst a first sensor is in use, and then subsequently swapped out so as to synthesize a sensor having a much longer lifetime. One way of avoiding the sensor from being used is to make sure that the current flow path between the working and counter electrodes is not made until it is desired to use the sensor. This provides an electrically based approach to leaving a sensor in reserve for use at a later date. Other approaches may include closing the opening 82 in the cap 80 by one or more further manufacturing steps and then selectively opening those openings at a later date. This may be achieved, for example, by forming a thin conductive film over one or more of the openings 82, and then passing a current through the thin conductive film in order to damage it, potentially melting or evaporating it, so as to open the gas flow path to the sensor. Other techniques may involve plugging a hole with a relatively low melting point material, for example a wax, which can be melted out of the hole by passing a current through a thermally coupled heating coil or resistive track. Other approaches may include the use of degradable materials to cover a gas inlet hole where the rate of degradation is selected such that a second sensor becomes exposed during the operational lifetime of a first sensor. This for a while only the first sensor is operating. As time progresses the second sensor becomes operational and for a while both sensors are working Then as the first sensor degrades, the second sensor takes over from the first sensor. In further embodiments mechanical actuators may be provided to open and/or close fluid flow paths or to drill holes in seals or open frangible closures. Where precision measurements are required, one or more of the sensors may be sealed in a known environment, for example containing the desired analyte at known concentration, and maybe periodically powered up in order to provide an in situ reference which may be used in comparison with or calibration for other sensors which are exposed to the ambient environment.

Other sensor configurations falling within the scope of the disclosure are also proposed.

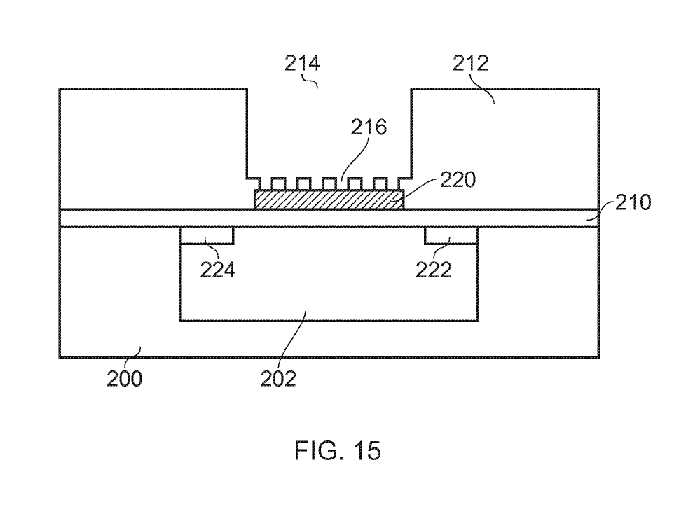

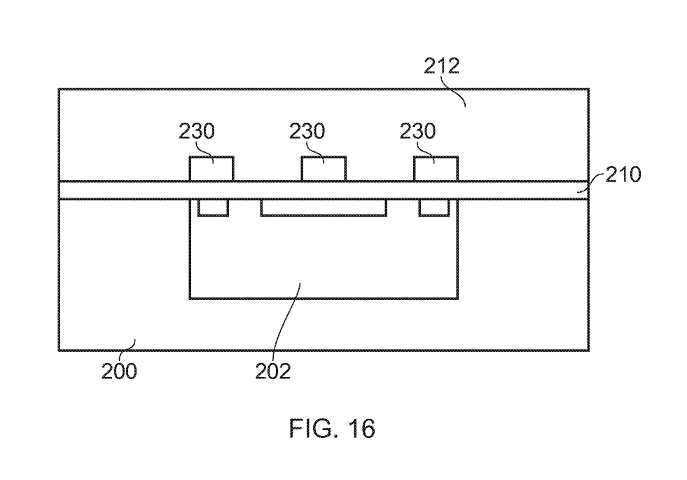

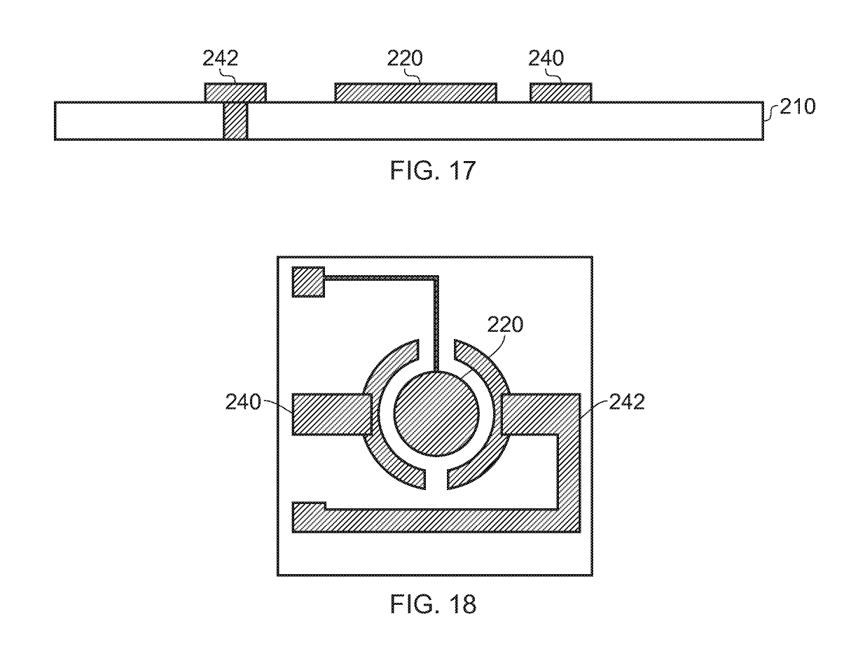

FIG. 15 schematically illustrates a further embodiment of a sensor in accordance with the teachings of this disclosure. The sensor comprises a base portion 200 which has a cavity 202 formed therein to act as a reservoir. The sensor shown in FIG. 15 is in its completed configuration, and during manufacture many hundreds of cavities 202 would be etched into a substrate 200, for example a semiconductor wafer, which subsequently is then diced to isolate the individual sensors (or groups of sensors) from one another. The base 200 is covered by an interposer 210 which separates the base 200 from a cap 212. As shown, the cap can be etched to form a recess 214 which is bounded by a grid of holes 216. If the interposer 210 is liquid permeable then one or more electrodes, of which working electrode 220 is shown in FIG. 15 may be provided on the side of the interposer 10 facing towards the cap. Further electrodes 222 may be formed on the underside of the interposer 210. The cavity 202 is filled with an electrolyte. Thus the sensor has electrolyte sealed in a closed volume. In a variation of the arrangement shown in FIG. 15, all of the electrodes may be provided on one side of the interposer and cover 216 may be of the type as shown in FIG. 15 or, as shown in FIG. 16, may have a plurality of fluid flow conduits 230 formed therein. These can attach to inlet and outlet ports to manifolds for the flow of liquids or gases over the porous interposer 210. The structure of the interposer 210 and the electrodes formed thereon are shown in greater details in FIGS. 17 and 18. FIG. 17 is a cross section view whereas FIG. 18 is a plan view. The electrodes may be printed or otherwise formed on the material of the interposer, which may be a porous plastic, a osmotic type membrane or a thin layer of silicon or other suitable material. This may include drilling or etching holes thorough materials such that the holes form gas flow paths but are sufficiently small such that the surface tension of the electrolyte stops it passing through the holes. The working electrode 220, the counter electrode 240 and the reference electrode 242 are, in this example, all formed on a first side of an interposer 210. A via may be provided for the purposes of controlling the potential of the base 200 with respect to the cap 212 or if it is desired, for using the interior of the reservoir as an electrode surface, as was described hereinbefore with respect to the first embodiment. Alternatively the via 244 may be omitted.

FIG. 18 shows, in plan view, the arrangement where the three electrodes, namely the working electrode, the counter electrode and reference electrode are all provided on the interposer. In this arrangement the working areas of the counter electrode and the reference electrode are provided as semicircular tracks separated from one another by gaps and generally surrounding the working electrode 220. One or more vias may be formed through the interposer to allow the electrodes to be in contact with respective terminals.

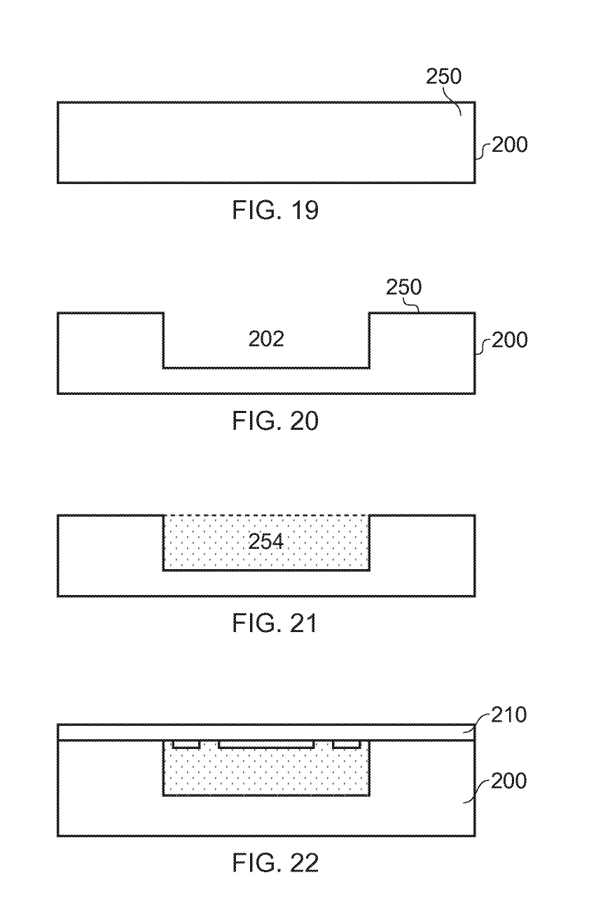

During manufacture, the process starts with a substrate, for example of silicon 250 as shown in FIG. 19. Next, as shown, the substrate 250 is masked, etched, and then the mask removed so as to form the cavity 202 within the substrate 250 that, in the finished device, forms the base 200. Then, and as shown in FIG. 21, the cavity 202 is filled with an electrolyte. The electrolyte may be in the form of a gel and be jet printed or screen printed into the cavity or vacuum filled. Finally, as shown in FIG. 22 the interposer layer carrying the electrodes is placed over the cavity 202 of the base 200 such that the electrodes are in contact with the electrolyte 254. Depending on the constructural technique chosen the electrodes on the interposer may either contact with respective conductive regions formed in a dielectric above the substrate 200 or be in contact with vias through the interposer 210 such that contacts on an upper side of the device (as illustrated) are exposed for subsequent wire bonding or similar connection. The arrangement is shown in FIG. 22. From here the cap 212 may then be bonded above the interposer 210 thereby arriving at the configuration shown in FIG. 15 or 16 depending on the electrode configuration in the interposer and the shape of the cap.

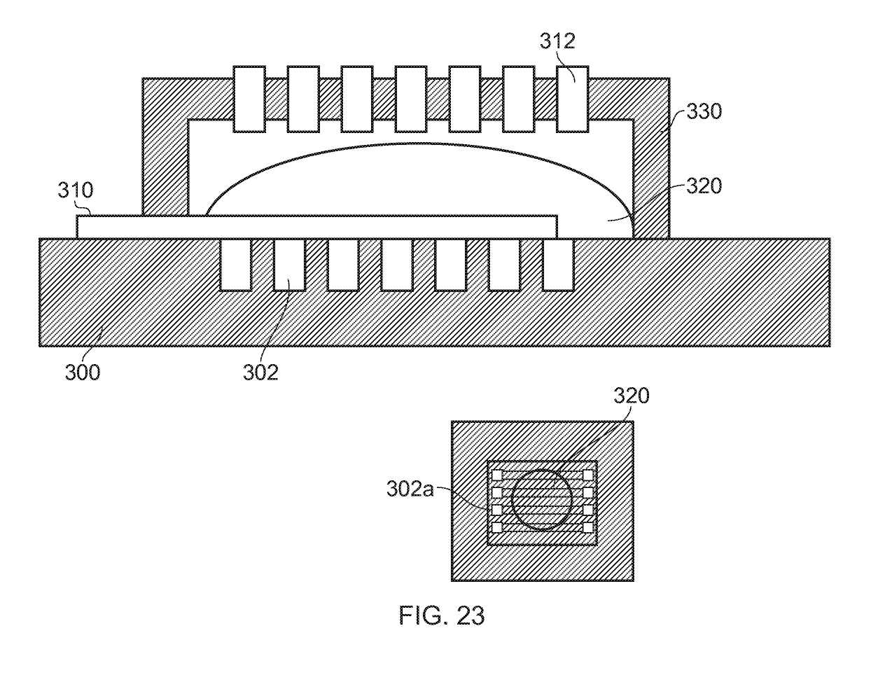

FIG. 23 shows a cross section through a sensor constituting a further embodiment of this disclosure. Here a substrate 300 is micro-machined to form a plurality of channels 302 in a surface of the substrate. In this example the channels 302 lie within the boundary of a cover 330. Two or more electrodes, of which only one electrode 310 is in the plane of cross section of FIG. 23, are formed over the substrate 300. An electrolyte 320 is positioned over the electrode 310 and the other electrode(s). The electrodes 310 are porous such that gas on the channels 302 can permeate through at least the electrode 310 to reach the electrolyte.

The electrolyte is enclosed by a cover 330 also formed by micro-machining The cover may have apertures formed in it which allow gas to reach end portions 302a of the channels 302. The channels 302 may, or may not, extend under the entirety of the electrodes. They serve to connect the gas permeable electrode to the ambient atmosphere. Alternatively the electrode need not be gas permeable, in which case the channels 302 can open directly into the volume beneath the cover so as to allow the gas to diffuse into the electrolyte.

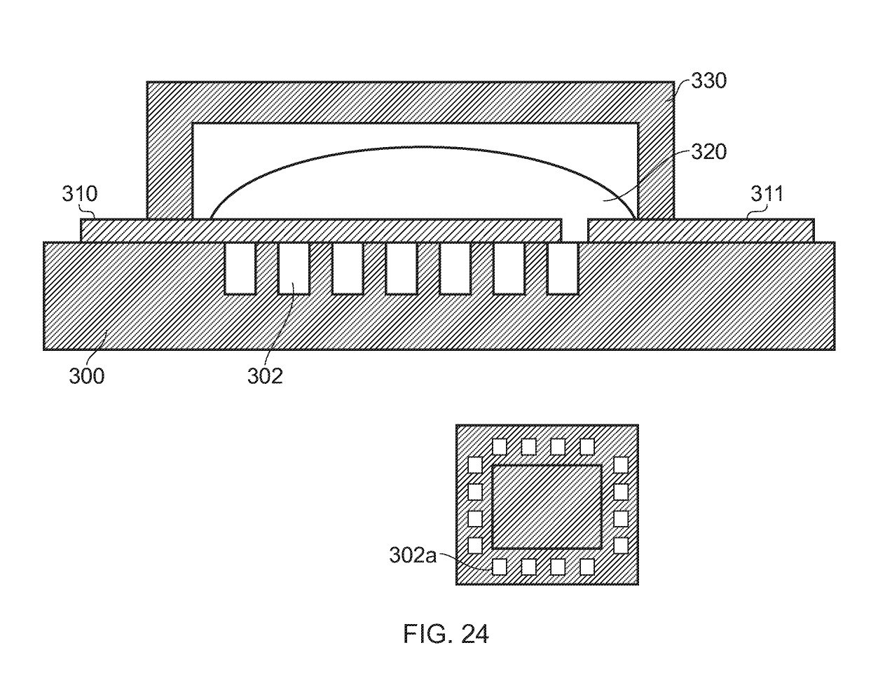

FIG. 24 shows a cross section through a further embodiment of a gas sensor which is much like that shown in FIG. 23. Here two electrodes 310 and 311 are visible in the plane of cross section of FIG. 24. The channels 302 open outside of the cap 330, and allow gas to permeate through the gas permeable electrode 310. In this embodiment the cap 330 does not have any apertures formed therein, but the regions 302a are outside of the cap 330.

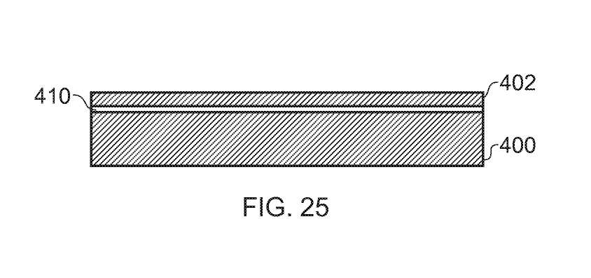

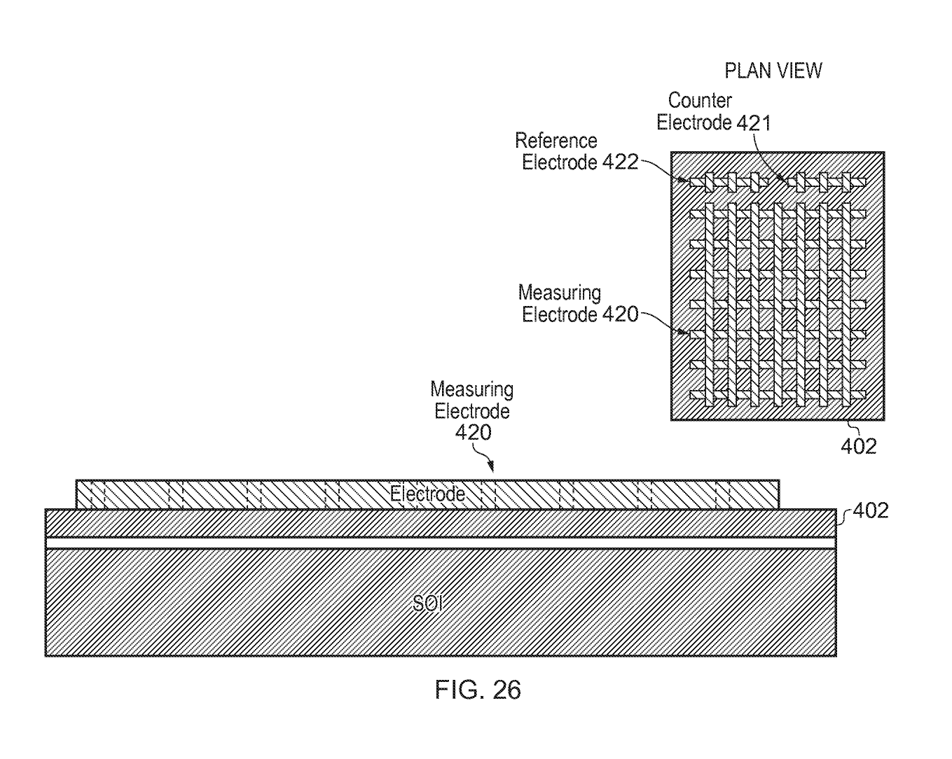

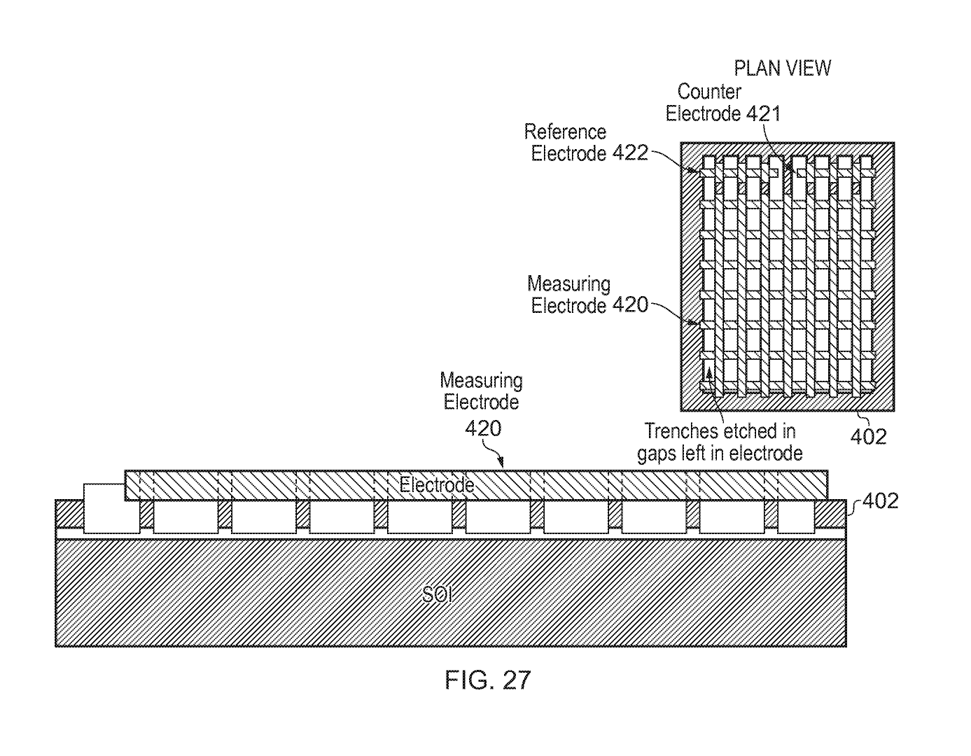

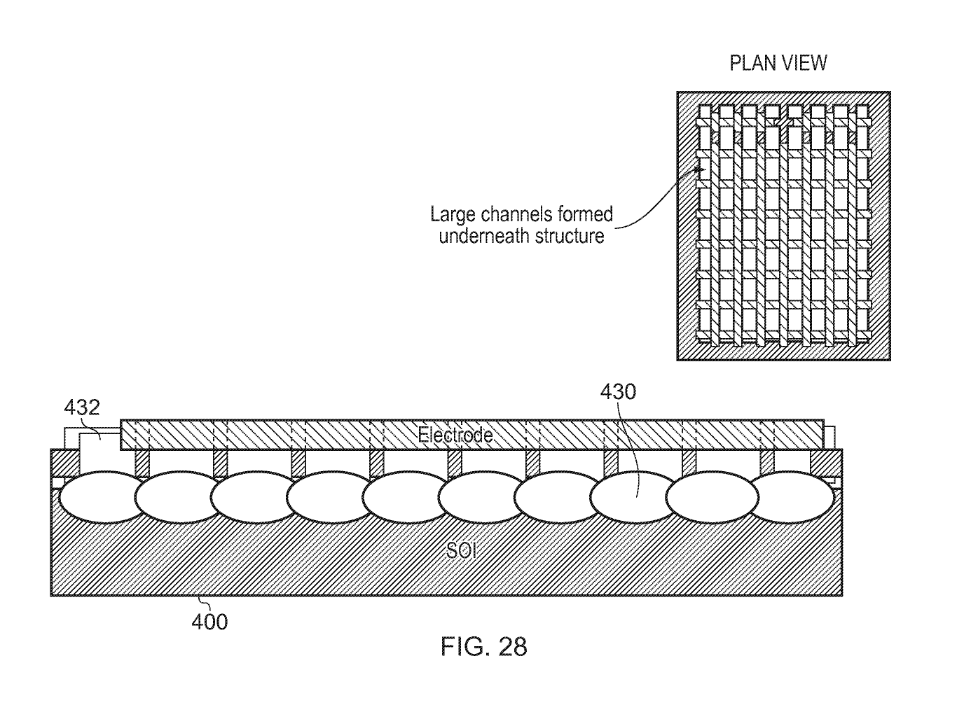

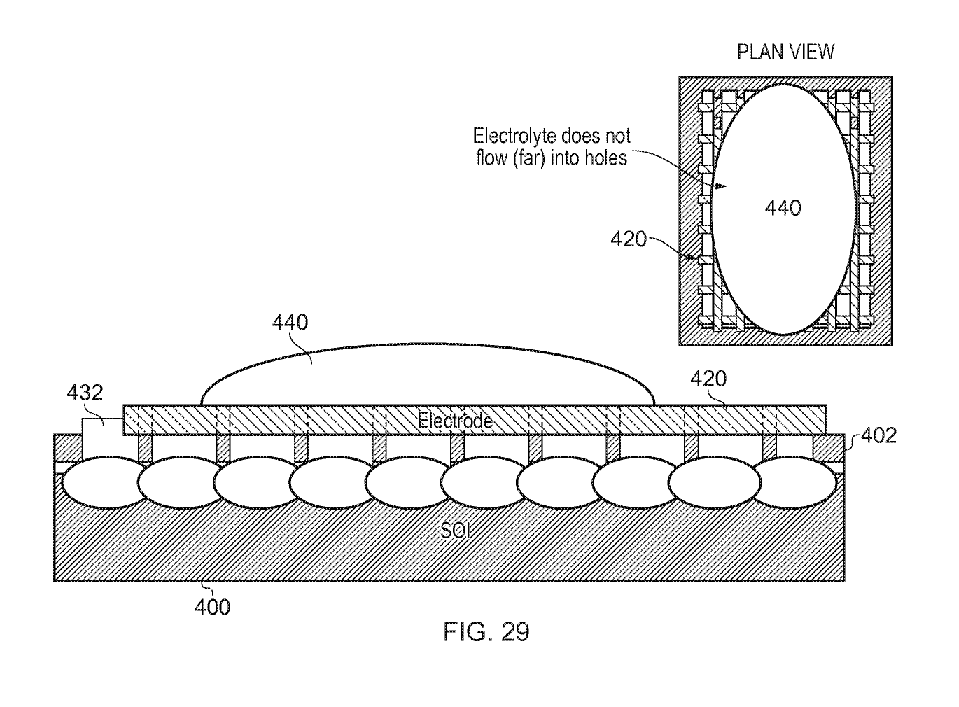

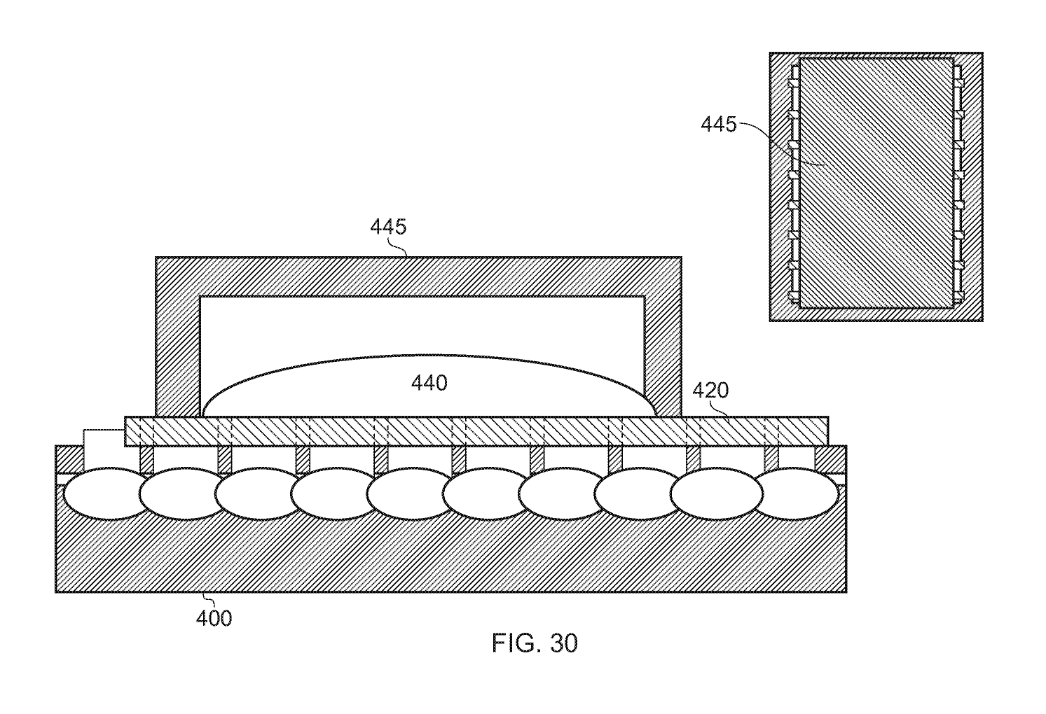

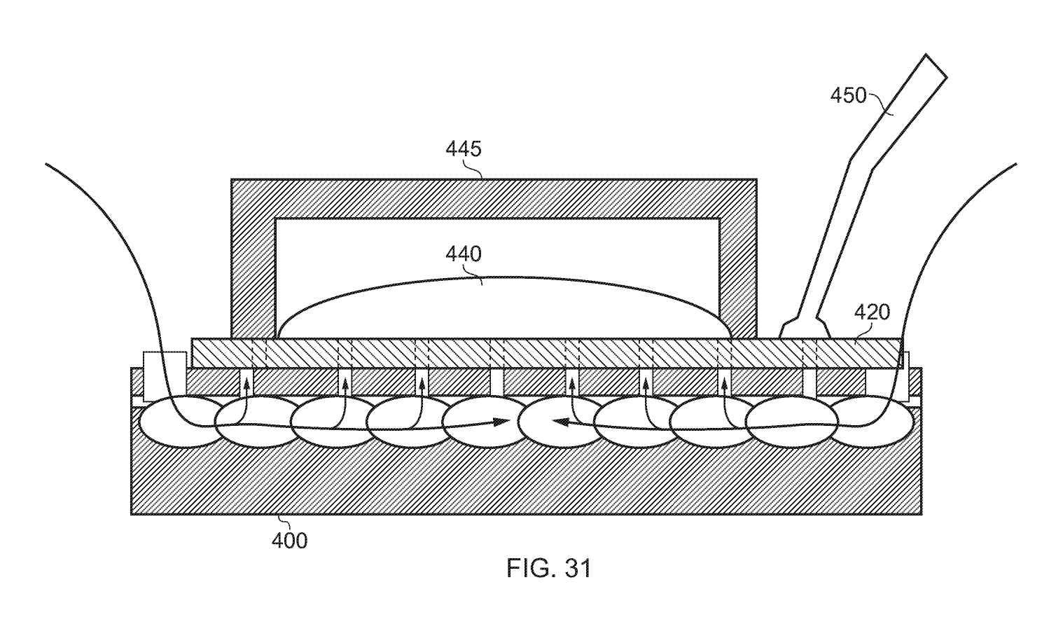

The formation of the embodiment shown in FIG. 24 can start with a Silicon on Insulator substrate, where a first layer of silicon 402 is formed over a silicon substrate (handle wafer) 400 and is isolated by a dielectric layer 410, of silicon oxide as shown in FIG. 25. From here, patterned electrodes are formed. Techniques for forming patterned electrodes are standard fabrication process options in semiconductor monolithic integrated circuit fabrication and need not be described in detail here. This gives rise to the structure shown in FIG. 26 where the electrode 420 is formed as a lattice and electrodes 421 and 422 are also provided. Following formation of the electrodes 420, 421 and 422, the wafer is etched such that those areas of silicon 402 not protected by the metal layer are etched away in a trench etching process, as shown in FIG. 27 After the trench etch of FIG. 27 has been completed a SF6 (sulphur hexafluoride) plasma etch to under-etch the electrodes by removing silicon from the layer 402, the substrate 400 and by removing the oxide layer 410, so as to arrive at the configuration shown in FIG. 28 where a gas channel 430 extends beneath the electrode 420, 421 and 422 to one or more gas ingress apertures 432. Then a volume of electrolyte 440 is positioned above the electrode, for example using a screen printing process, such processes being useful in semiconductor processing. The resulting wafer is shown in FIG. 29. Then the wafer may have a cap 445 secured to it, for example by adhesive or other low temperature bonding steps, resulting in the structure of FIG. 30. The completed structure, including a wire bond 450 to the electrode (other wire bonds exist outside the plane of the drawing in FIG. 31) and the gas flow paths are illustrated in FIG. 31.

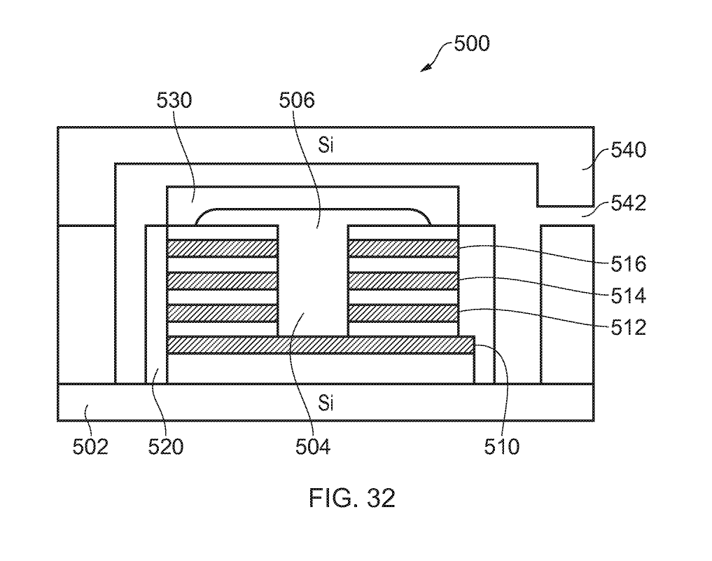

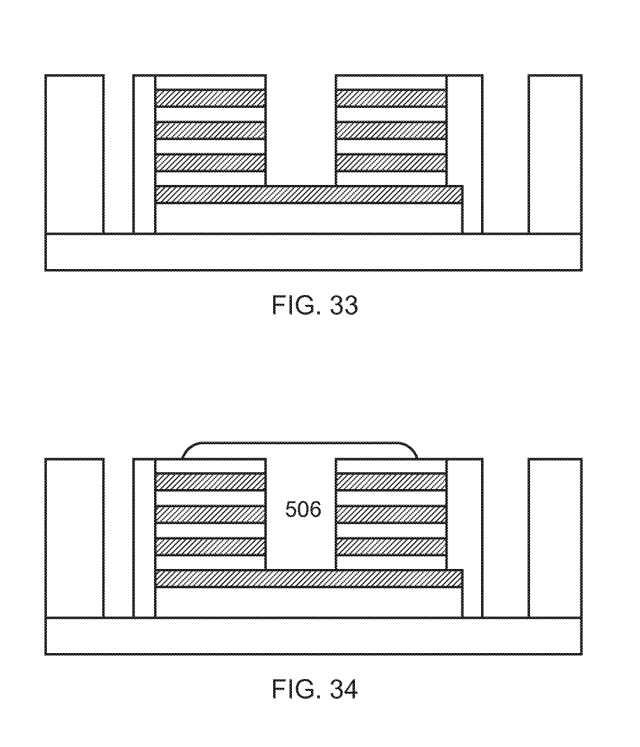

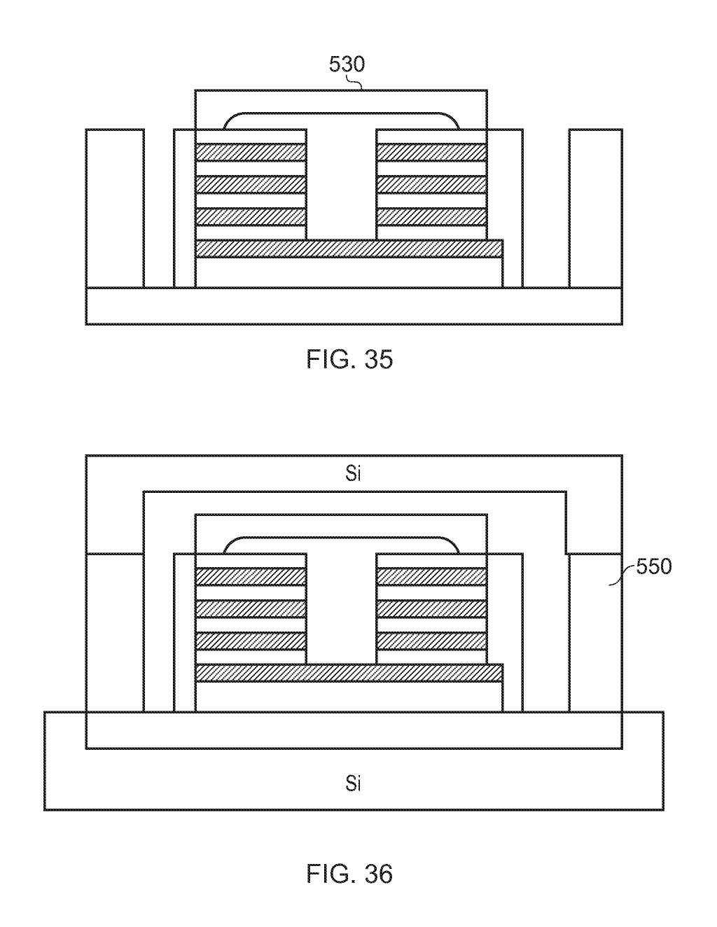

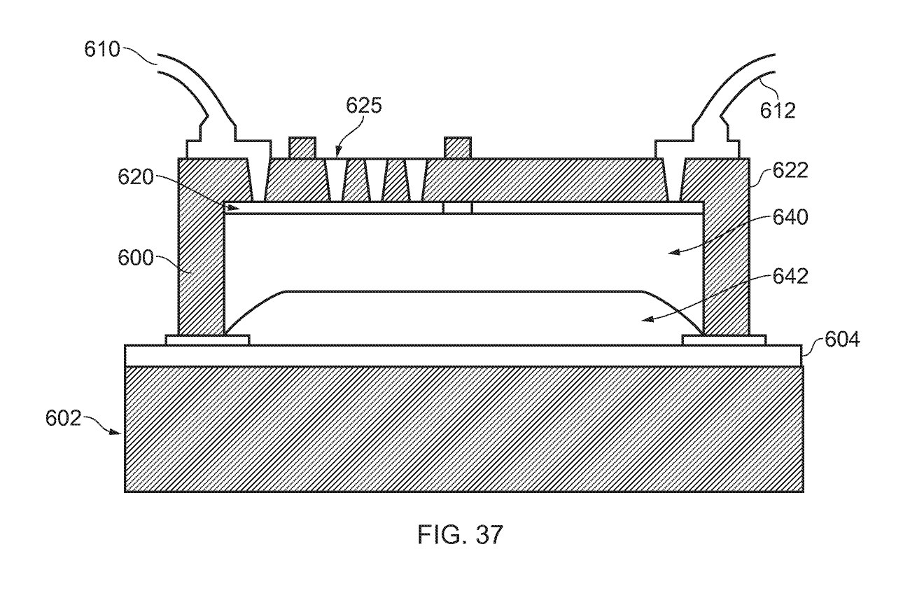

FIG. 32 is a cross section through a gas sensor 500 constituting a further embodiment of this disclosure. The sensor comprises a base 502 which has been processed using micro fabrication techniques to form a reservoir 504 which, in the finished device, holds an electrolyte 506. In the arrangement shown if FIG. 32 the reservoir may sit over the substrate, such as a silicon substrate or it may be bounded by another layer of material such as a layer of Aluminium or copper. This could form an electrode or it may simply serve as a base layer over which layers of dielectric material, such as silicon oxide or silicon nitride may be formed along with suitably positioned electrodes 512, 514 and 516 which can serve to form the counter electrode, reference electrode and working electrode. The working electrodes may be formed of material such as gold, platinum or any other suitable material. The electrode layers may, be bounded by a bounded by a wall of material 520, which may be protective/passivation layer, for example of oxide or nitride, so as to protect the electrodes against inadvertent exposure. The reservoir is covered by a diffusion membrane 530 of gas permeable polymer and/or hydrophobic polymer. A protective cap 540, optionally machined or etched to form one or more diffusion apertures 542 may be secured over the base and the reservoir. FIGS. 33 to 36 show some of the steps in the fabrication process following on from the fabrication of the base, reservoir and electrodes, which can be formed by adapting the teachings given earlier on for the formation of the first embodiment. From FIG. 33, where the base is completed, the electrolyte is introduced into the reservoir, for example by ink jet printing, to arrive at the structure of FIG. 34. From the, and as shown in FIG. 35 the gas permeable membrane 530 is added. Then the structure is capped as shown in FIG. 36. FIG. 36 also shows that in a variation one or more channels may be etched through or beneath the side wall 550 of the sensor to provide a simplified cap structure.

FIG. 7 shows a further variation of a sensor where a cap structure 600 is formed over a substrate 602 optionally over some dielectric 604. The cap 600 has a number of apertures formed therein in order to form conductive vias between electrodes 610 and 612 and respective electrodes 620 and 622. The electrode 620 may form the working electrode and it may be in contact with gas paths 625 formed by way of vias in the cap. The gas paths may be plugged with a gas permeable material in order to allow gas to reach the working electrode but to reduce the rate of evaporation of water from the electrolyte. The electrolyte 640 may be a hydrogel and may be placed above a further cavity 642 which may be provided to allow for expansion and/or which may have water placed in it to act as a reservoir for the hydrogel.

Various other variations may also be possible, thereby allowing bigger reservoirs to be formed, or collections of devices to be formed as a multi-sensor array. This may be provided by forming a sensor “chassis” where the electrodes and mirco-machined structures are formed across a wafer—and indeed a wafer may contain dissimilar structures—so as to allow for gas and liquid sensing—and where the electrolyte is varied between sensors to allow a single sensor group to detect various analytes, where the sensor group may be on a shared semiconductor or micro-machined substrate.

The claims presented herein are in single dependency format suitable for filing at the United States Patent & Trademark Office. However it is to be assumed that each one of the claims can be multiply dependent on any preceding claim except where that is technically unfeasible.

1. A method of forming an electrochemical sensor, the method comprising using a lithographic technique and an etching technique to process a substrate to form an electrochemical sensor having an enclosed electrolyte in electrical communication with at least first and second electrodes.

2. A method as claimed in claim 1, in which the substrate is a wafer that is processable using an integrated circuit manufacturing technique.

3. A method as claimed in claim 2, in which the substrate is selectively etched to form at least one reservoir therein, and in a subsequent step the at least one reservoir is at least partially filled with an electrolyte.

4. A method as claimed in claim 3, in which prior to introducing the electrolyte into the reservoir, an internal surface of the reservoir is coated with a material to form a counter electrode.

5. A method as claimed in claim 3, further comprising forming a layer of material as a working electrode on a first side of the wafer, prior to etching the substrate, wherein the etching exposes portions of the working electrode to the at least one reservoir.

6. A method as claimed in claim 5, in which the working electrode is porous.

7. A method as claimed in claim 3, further comprising sealing the reservoir with a cover.

8. A method as claimed in claim 1, comprising grouping at least two sensors to form a sensor unit, wherein one of the sensors is encapsulated with an analyte under specified conditions so as to act as a reference.

9. A method as claimed in claim 1, comprising forming a working electrode, a counter electrode and a reference electrode in a stacked configuration.

10. A method as claimed in claim 1, further comprising forming a cap and bonding the cap to the substrate, said acts being performed using one or more semiconductor processing techniques.

11. A method as claimed in claim 1, in which at least two electrodes are formed on a layer or a substrate different from the substrate forming a reservoir for the electrolyte.

12. A method as claimed in claim 1, in which the at least two electrodes are formed on a gas permeable membrane or gas permeable sheet of material.

13. A method as claimed in claim 12, further comprising placing a cap or cover over the gas permeable membrane or sheet of material, and wherein the cap or cover has one or more gas flow paths formed therein.

14. A method as claimed in claim 1, comprising forming electrodes as a planar structure, printing the electrolyte over the electrodes and capping the sensor.

15. A method as claimed in claim 14, further comprising etching one or more apertures in the electrode and an underlying structure to form a gas flow path to the electrolyte.

16. A method of calibrating a sensor, comprising forming a plurality of nominally identical sensors on a substrate using integrated circuit formation techniques including photolithographic and etching steps, selecting at least one sensor from the plurality of sensors for characterization, characterizing the selected at least one sensor, and using the characterization data obtained as representative of one or more of the other sensors formed on the substrate.

17. An electrochemical sensor comprising an electrolyte enclosed within a micromachined structure.

18. An electrochemical sensor as claimed in claim 17 wherein the micromachined structure comprises a semiconductor wafer.

19. An electrochemical sensor as claimed in claim 17, wherein a working electrode is formed on a first surface of the substrate, and at least one of a counter electrode an a reference electrode is formed in a body of the substrate and in contact with a reservoir holding the electrolyte.

20. A method of forming an electrochemical sensor as claimed in claim 1, in which a working electrode, a counter electrode and a reference electrode are formed on an interposer between a base and a cap of the sensor.

21. A sensor array comprising a plurality of nominally identical sensors, wherein at least some of the sensors are provided with openings closed by a closure which can be electrically opened.

22. A sensor array as claimed in claim 21, in which the closure comprises an electrically conductive thin film.
